(19) United States
(12) Patent Application Publication
(10) Pub. No.: US 2003/0093170 A1
(43) Pub. Date: May 15, 2003

(54) System and method for manufacturing a material using concurrent dimension certification

(76) Inventor: Benjamin Angeles Escobar JR., Des Plains, IL (US)

Correspondence Address: Gary R. Maze, Duane, Morris & Heckscher LLP, Suite 500, One Greenway Plaza, Houston, TX, 77046, US

(21) Appl. No.: 10/045,370

(22) Filed: Nov. 9, 2001

(51) Int. Cl. G06F 19/00

(52) U.S. Cl. 700/109; 700/117

(57) ABSTRACT

A system and method for cutting material, adaptable for use with existing manufacturing devices, where the system can be adapted to work with existing controllable manufacturing processors, obtain one or more predetermined dimensions during a manufacturing process, and use those dimensions to simultaneously control the manufacturing process while generating a concurrent certification of the predetermined dimensions. In an exemplary embodiment the device comprises a milling line; a stepper motor; a mainframe; a protected real-time sensor; a controller; and a computer in communication with the controller and sensor. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### BACKGROUND OF THE INVENTION

1. Field of the Invention

The present inventions relate to the field of milling. More specifically, the present invention, in an exemplary embodiment, relates to a system and method for milling material while simultaneously obtaining measurements of predetermine dimensions of that material after processing and generating a certification of those dimensions.

2. Description of the Related Art

In the milling and forming arts, material which is cut or otherwise processed is often required to be inspected for adherence to predetermined tolerances. Certification that these dimensions of the piece as milled or processed are within a predetermined range is also often required. However, in the prior art, such certification is typically a manual and time consuming process.

Numerical or other computerized process controls are known in the prior art. U.S. Pat. No. 5,917,726 to Pryor for INTELLIGENT MACHINING AND MANUFACTURING is illustrative. Pryor '726 teaches methods and apparatus for “intelligent” control of production processes such as machining, casting, heat treating and welding are disclosed. Pryor '726 uses electro-optical or other suitable sensors, generally non-contact sensors, capable of acquiring data from parts and tools used to produce them in a production “in-process” environment. However, Pryor '726 does not teach concurrent certification of predetermined dimensions during the manufacture of a material such as a metal. Additionally, the electro-optical used for the Pryor '726 is for capturing images. Based of the data captured from the image, the process is performed.

U.S. Pat. No. 5,362,970 to Pryor et al. for a METHOD AND APPARATUS FOR ELECTRO-OPTICALLY DETERMING THE DIMENSION, LOCATION AND ATTITUDE OF OBJECTS is similar and teaches a method and apparatus for optic ally determining the dimension of part surfaces such as with optical triangulation based coordinate measurement. Pryor '970 does not teach calculating an adjustment of the moving table on which a material is placed using sensed dimensions and sending signals to each of the stepper motors based on the calculated adjustment. Further, Pryor '970 does not teach or suggest concurrent certification of predetermined dimensions during the manufacture of a material such as a metal.

U.S. Pat. No. 5,910,894 to Pryor for SENSOR BASED ASSEMBLY TOOLING IMPROVEMENTS teaches a method and apparatus for assembly particularly addressed to the assembly of automobiles and aircraft done with reconfigurable modular and “intelligent” tooling fixtures (also called jigs, or holding fixtures). Much of the capability of the system is brought by the optical or other non-contact sensing devices incorporated with the tools to provide information on part location, tooling detail location, and automation (such as robots), used to load, weld, rivet, or otherwise perform work with parts in the tool. Ranging and feature location sensors operating in real time perform numerous measurements of location of critical features of assembly tools and the parts placed within them. A computer system associated with the sensors builds up a data base of part condition before, during and after assembly functions. Pryor '894 is primarily directed towards method of joining sheet metal components to form an assembled sheet metal part. Pryor '894 does not disclose calculating an adjustment of the moving table on which a metal is placed using sensed dimensions and sending signals to each of the stepper motors based on the calculated adjustment. Further, Pryor '970 does not disclose concurrent certification of predetermined dimensions during the manufacture of a material such as a metal.

Therefore, there is a need to be able to control a materials process in real time that additionally certifies in real time that the dimensions of materials as processed meet the tolerances required.

### BRIEF DESCRIPTION OF THE DRAWINGS

These and other features, aspects, and advantages of the present invention will become more fully apparent from the following description, appended claims, and accompanying drawings in which:

FIG. 1 is a plan view of a representative prior art system in partial perspective;

FIG. 2 is a plan view of an exemplary embodiment of the present inventions, and FIG. 2a is a close-up of a guide as used in the exemplary embodiment;

FIG. 3 is a plan view in partial perspective of a mainframe assembly 102 of the present inventions;

FIG. 4 is an alternate plan view in partial perspective of a mainframe assembly of the present inventions;

FIG. 5 is a schematic view of display; and

FIG. 6 is a block diagram of an exemplary automated inspection controller system.

### DETAILED DESCRIPTION OF THE PREFERRED EMBODIMENT

As used herein, “material” may be a metal, plastic, glass, paper, organic materials, composites, or other material that can be processed on a milling line. “Processed” is broadly defined to include cutting, shaping, etching, assembling, welding, riveting, progressive dies, stamping, and the like. “Materials processor” is defined to be an apparatus to accomplish this processing. “Milling line” is defined to be a set of apparatuses, including a materials processor, to accomplish this processing.

The novel features of the present inventions comprise a system that can be adapted to work with existing controllable manufacturing processors and that can obtain one or more predetermined dimensions during a manufacturing process and use those dimensions to simultaneously control the manufacturing process while generating a concurrent certification of the predetermined dimensions during the manufacturing process. In an exemplary embodiment, the present inventions may be installed to cooperatively exist with existing processing machines such as cutting, blanking, multi-blanking and various progressive press machines.

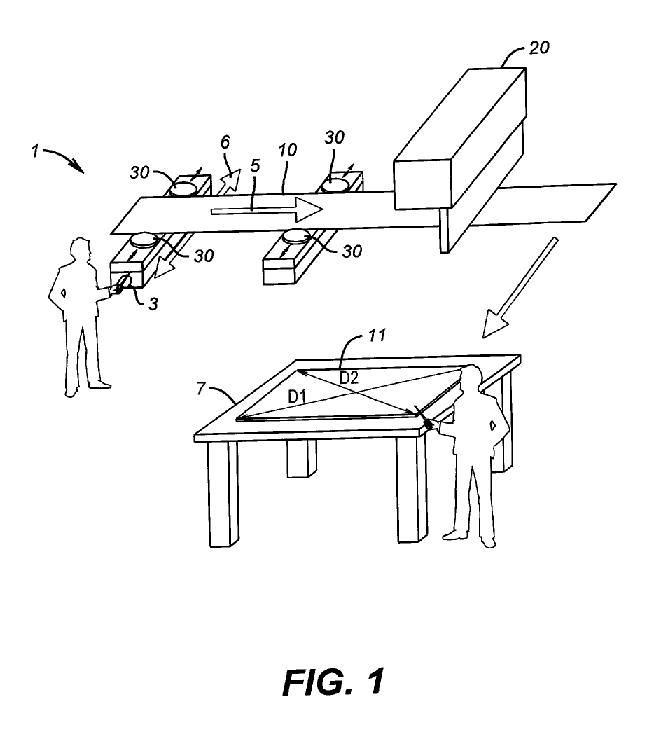

Referring now to FIG. 1, a plan view of a representative prior art system in partial perspective, material 10 is fed in a direction indicated by arrow 5 on milling line, generally referred to by the numeral “1” and underneath cutter 20. Cut piece 11 must be removed, such as to table 7, to be manually inspected, measured, and certified. Guides 30 may be present to help align material 10 with respect to cutter 20 but are manually adjusted such as with adjuster 3 in one or more directions such as indicated by arrow 6.

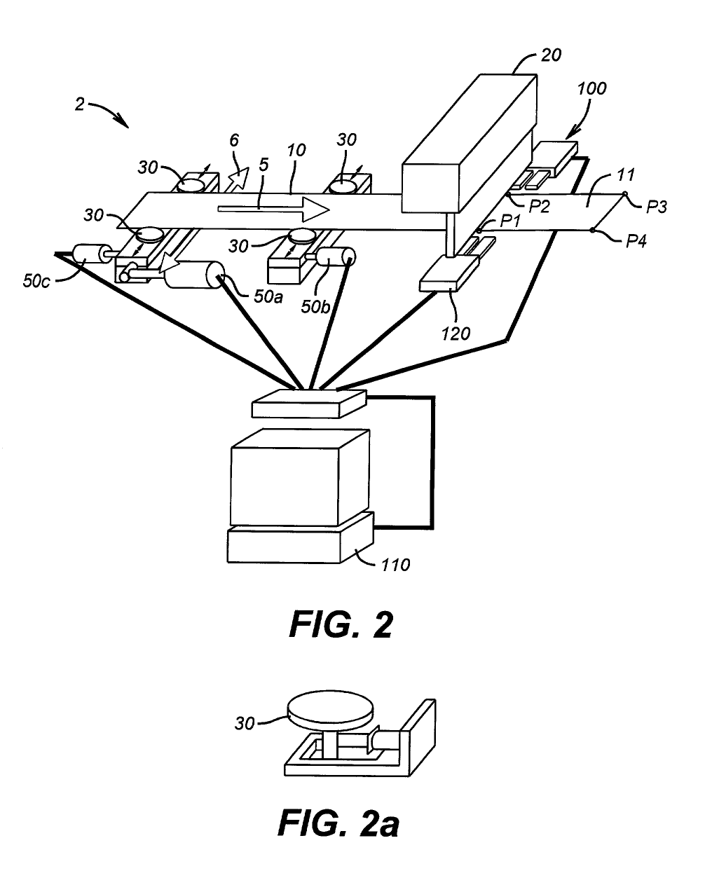

Referring now to FIG. 2, a plan view of an embodiment of the present system in partial perspective, the automated inspection controller system of the present inventions is generally referred to by the numeral “100.” One or more stepper motors, generally referred to by the numeral “50” and shown as stepper motor 50a, 50b, and 50c, may be present and controlled by computer 110. As more clearly indicated in FIG. 2a, guides 50 may comprise wheels adjustably mounted and adjustable in at least one plane, such as with a solenoid or cylinder (not shown in FIG. 2a).

One or more sensors, generally referred to by the numeral “120” such as position sensor 120 are also present and operatively connected to computer 110. In a preferred embodiment, sensor 120 captures the positioning of the material being processed by contacting the material to be processed. Accordingly, in this preferred embodiment sensor 120 comprises pressure sensors which are at least partially in physical contact with a predetermined portion of the materials to be processed. However, sensor 120 is any sensor capable of detecting the desired measurements, by way of example and not limitation comprising pressure sensors, acoustic sensors, and optical sensors.

Using a predetermined characteristic of the positioning, which in a preferred embodiment is the intensity of the sensed contact, controller system 100 may make calculations necessary to run stepper motors 50 clockwise or counter-clockwise as well as other adjustments and/or directives for other adjusting devices, by way of example and not limitation such as motors, hydraulics, and/or switches.

In a preferred embodiment, multiple dimensional measurements are taken in real-time, by way of example indicated as points P1, P2, P3, and P4. Accordingly, cut piece 11 does not need to be removed from milling line 1 as shown in FIG. 1 for manual inspection, measurement, and certification.

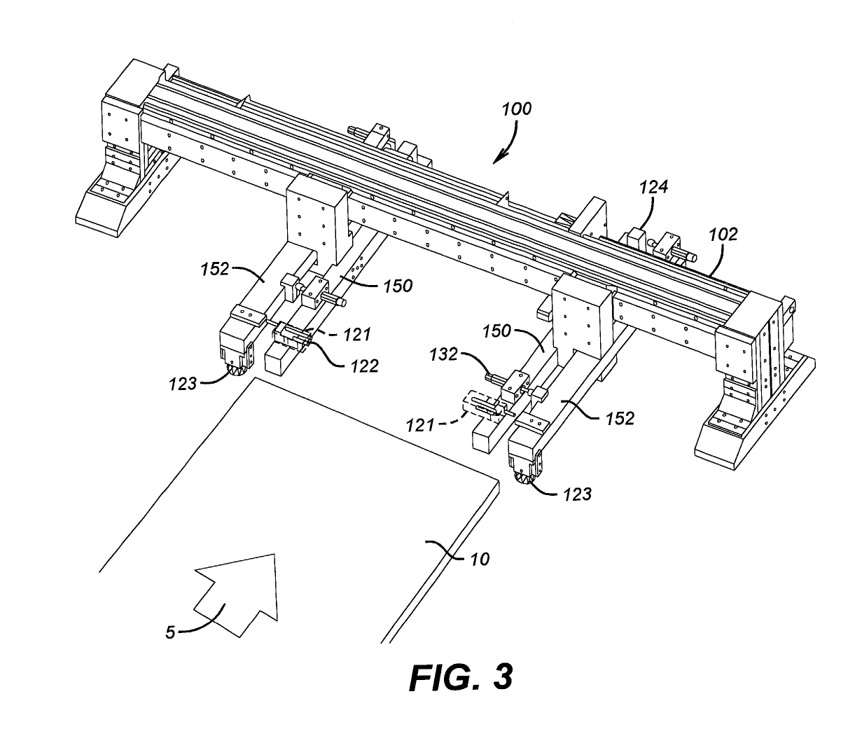

Referring now to FIG. 3, a plan view in partial perspective of a mainframe assembly 102 of the present inventions, mainframe 102 may be adapted for installation with presently installed processing machines such as with presently installed milling machines (not shown in FIG. 3 but shown generally as cutter 20 in FIG. 2). Material 10 is fed proximate mainframe 102 in the direction of arrow 5. Sensors such as sensor 122 and cut sensor 124 may be positioned proximate mainframe 102. Additionally, gauges such as linear gauge 132 may also be positioned proximate mainframe 102.

A sensor 120 such as sensor 122 may be mounted to arm 150 which is fixed relative to mainframe 102. In a currently preferred embodiment, sensor 122 is protected from environmental conditions such as jostling, pressure, touch, dust, contaminants, and the like, by way of example and not limitation such as being situated within sensor housing 121. Arm 152 may be movable in at least one plane relative to mainframe 102. Material 10 may be in communication with arm 152 such that as arm 152 moves, sensor 122 adjustably contacts a portion of material 10 and/or arm 152. Thus, in a preferred embodiment, sensor 122 may generate a signal that is proportional to the amount of contact of sensor 122 with either arm 152, material 10, or both. One or both of arms 152, as shown in the figure, may be movable.

Additionally, roller 123 may be positioned proximate to or mounted on arm 152 and contact material 10 to facilitate movement of material 10 with respect to arm 152. Roller 123 may be constructed of any material suitable for use with material 10 to be milled.

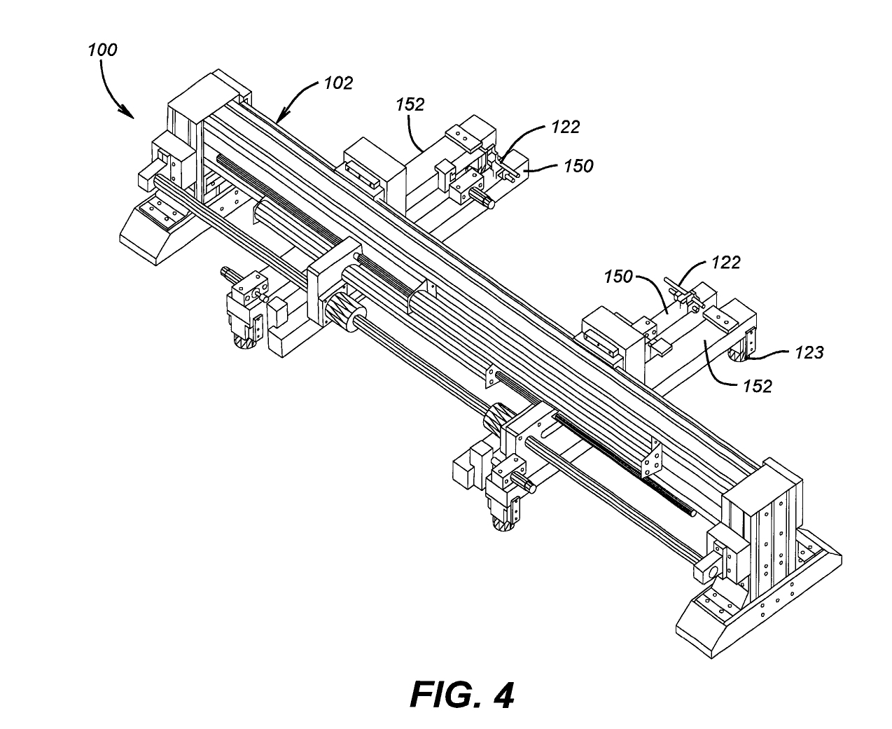

Referring now to FIG. 4, an alternate plan view in partial perspective of a mainframe assembly 102 of the present inventions, buckling sensor 126 may be positioned proximate mainframe 102.

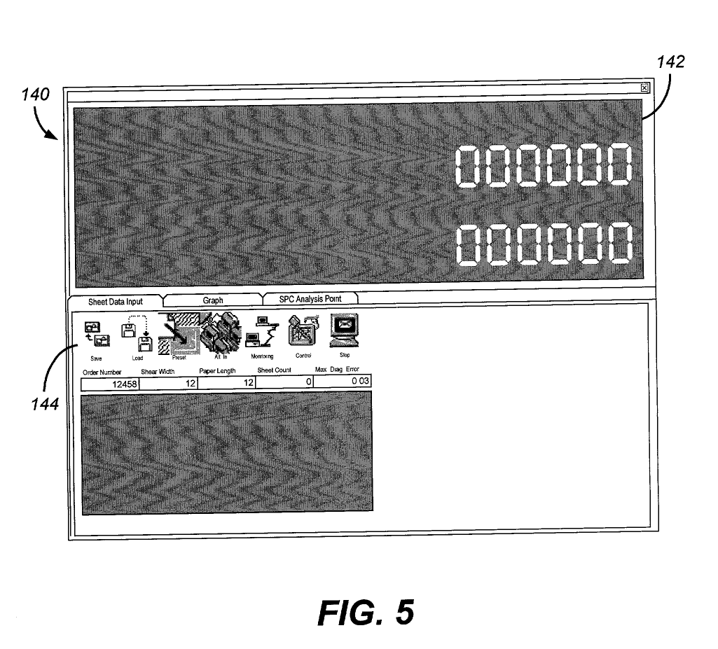

Referring now to FIG. 5, a schematic view of display 140, automated inspection controller system 100 may further comprise display 140 operatively connected to computer 110. Various regions of display 140 may be used for presentment of system information, such as at 142. This information may comprise information regarding the real-time operations and states of computer 110 and other components of automated inspection controller system 100 such as sensors 120 and gauges 130. Icons or other regions of display 140 may be used to establish control dialogs between system operators and computer 110, e.g. at 144. By way of example and not limitation, icons present at 144 may be used to stop or start the system, control one or more stepper motors 50, and the like.

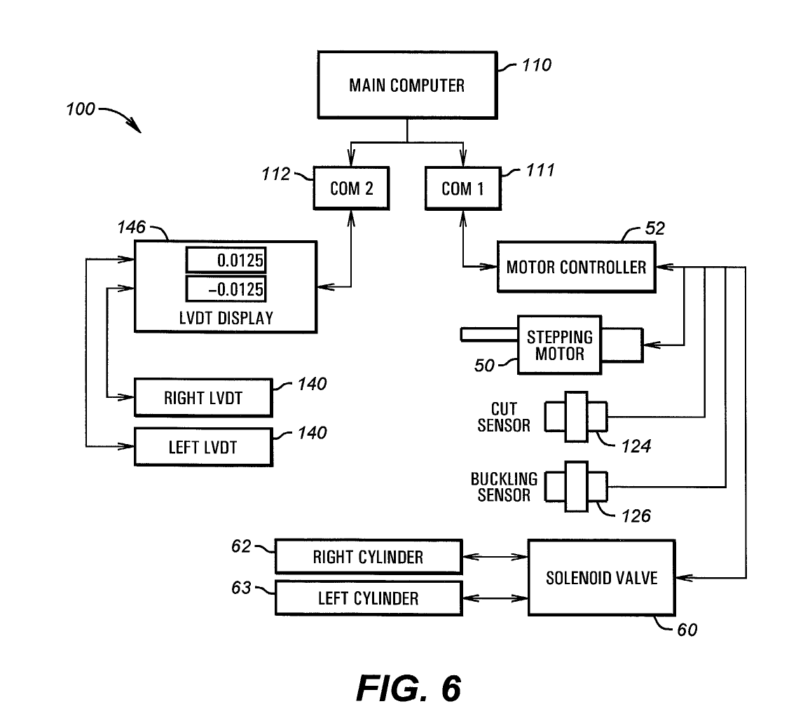

Referring now to FIG. 6, a block diagram of an exemplary automated inspection controller system 100, computer 110 is in communication with various components of automated inspection controller system 100 such as via data communications channels 111,112. Display 140 may additionally be display controller 146 in communication with a plurality of displays 140.

In addition to communications with sensors 120 such as cut sensor 124 and buckling sensor 126, computer 110 interfaces with stepper motor 50 such as via a dedicated stepper motor controller 52, although stepper motor controller 52 may not be needed if computer 110 is able to communicate directly with stepper motor 50.

Additionally, computer 110 may communicate with solenoid valve 60 to control one or more cylinders, shown in FIG. 6 as cylinders 62 and 63. Cylinders 62, 63 may be used to aid in the control of guides 30 (shown in FIG. 2 and FIG. 2a).

As will be understood by those of ordinary skill in the computer arts, communications between computer 110 and these various system components may be by any essentially equivalent means, by way of example and not limitation including wired or wireless, synchronous or asynchronous, serial or parallel, common bus or dedicated line, or the like.

In the operation of an exemplary embodiment, referring again to FIG. 2, material 10 which will be processed such as at cutter 20 is placed onto milling line 2. Material 10 may be a single piece of material or be part of a larger set of material such as a continuous roll.

In currently anticipated embodiments, a plurality of stepper motors 50 such as stepper motor 50a, stepper motor 50b, and stepper motor 50c may be present to help guide material 10 along milling line 2 as cutting progresses. Each stepper motor 50 may additionally have tensioner 30, such as a spring or pneumatic or hydraulic tensioner, connected to stepper motor 50 to maintain a pressure between stepper motor 50 and material 10 at a predetermined pressure. In FIG. 2a, this is shown in an exemplary embodiment as a spring loaded wheel.

Once material 10 is placed onto milling line 2 and stepper motor 50 tensioned, if so configured, computer 110 is initialized and begins to receive data from its various sources including sensors 120. In certain currently envisioned embodiments, computer 110 interfaces with one or more additional computers or controllers (not shown in the figures) and may thus participate in a coordinated sequencing and control system. Computer 110 may further initialize sensors 120, gauges 130, and stepper motors 50.

Once initialized, computer 110 receives continuous measurements of one or more predetermined dimensions of material 10, in a currently preferred embodiment the width of material 10. These continues measurements may be obtained at predetermined intervals, by way of example and not limitation such as every approximately ten microseconds.

As computer 110 continues to monitor its sensors 120 for dimension measurements, computer 110 may send signals to stepper motor 50 to rotate stepper motor 50 in a given direction with respect to the predetermined dimension of interest. In a preferred embodiment, computer 110 uses a set of measurements of predetermined ends of the material as processed and their diagonal to calculate an error, if present, in desired dimensions such as with the Pythagorean theorem.

Additionally, computer 110 may receive data from sensor 120 regarding adherence of the cutting process to the predetermined dimensional parameters of interest. In a preferred embodiment, computer 110 utilizes its obtained sensed measurements to calculate the shape of material 10, e.g. a coil, and determine a direction and amount of rotation needed by each stepper motor 50 in the system to keep material 110 within acceptable tolerances. Computer 110 further continues to receive data indicative of cutting such as from cutting sensor 124 and gauges such as linear gauge 132. As required, computer 110 will continue to control stepper motor 50 to continuously adjust material 10 on milling line 2 as material 110 passes cutter 20 to insure that material 10 as cut maintains the predetermined dimensional measurements within acceptable tolerances. In a preferred embodiment, computer 110 calculates adjustments needed for a single X-Y plane of material 10 by calculating a diagonal and width error for each cut.

In an exemplary embodiment, the predetermined dimensional measurements are indicative of the squareness of the cut piece.

Additionally, computer 110 may maintain a record of the dimensional measurements to produce a report in real-time of those measurements. The report may be reproduced such as on display 140, on hard copy such as via a printer (not shown in the figures), via a data communications device such as a fax or e-mail (not shown in the figures), or the like, or combinations thereof.

In currently preferred embodiments, computer 110 is also able to detect and react to predetermined abnormal conditions. By way of example and not limitation, if material 10 buckles during feeding, buckling sensor 126 may be activated. When activation of buckling sensor 126 is sensed by computer 110, computer 110 may then take appropriate measures such as removing tension or altering tension from one or more stepper motors 50. In a similar fashion, the system of the present inventions may also react to material 10 escaping from between guide wheels 30.

The present inventions take the data obtained in real-time such as from sensor 120 and use the data to correct processing of the next piece to be processed in real-time. These data may then be listed such as on a hard copy printout and/or on a computer screen such as display 140. As opposed to the prior art, the present inventions are thus able to create a report in real-time describing the inspected, finished product. By way of example and not limitation, certification reports of the present inventions may include calculated “real-time” statistical process control charts for the operator. Certification reports of the present inventions may further include print outs to provide listings of dimensions of the material as processed and capability process charts for the customers and quality assurance and/or quality certification auditors may be shown on display 140.

It will be understood that various changes in the details, materials, and arrangements of the parts which have been described and illustrated above in order to explain the nature of this invention may be made by those skilled in the art without departing from the principle and scope of the invention as recited in the following claims.

We claim:

1) A method of processing material, comprising:
a. placing the material onto a milling line for processing;
b. initializing a sensor positioned to sense a measurement of a predetermined characteristic of a predetermined portion of the material, the sensor protected by a sensor housing;
c. initializing a stepper motor, disposed proximate the line, to a predetermined position;
d. processing the material at a predetermined location along the milling line;
e. sensing a predetermined characteristic of the material on the milling line;
f. calculating an adjustment of the material in a predetermined plane using the sensed characteristic;
g. sending a signal to the stepper motor based on the calculated adjustment, if the adjustment is non-zero; and
h. retaining the sensed characteristic of the material for certification of the sensed characteristic.

2) The method of claim 1 wherein step (e) further comprises sensing a predetermined characteristic of the material on the milling line by physical contact of the sensor with the material to be processed.

3) The method of claim 1 wherein the sensed characteristic comprises a measurement of a predetermined portion of the material in a single plane.

4) The method of claim 1 wherein the sensed characteristic comprises a measurement of length of at least one side of the material and a diagonal of the material.

5) The method of claim 1 wherein the sensed characteristic comprises a measurement of length of a plurality of sides of the material and a calculated diagonal of the material.

6) The method of claim 1 further comprising generating a certification of the predetermined characteristic based on the retaining sensed characteristic.

7) The method of claim 6 wherein the certification comprises a report indicative of calculated “real-time” statistical process control charts, listings of dimensions as processed, and capability process charts.

8) The method of claim 6 wherein the certification is generated in real-time.

9) The method of claim 1 wherein the material is at least one of metal, plastic, glass, paper, organic materials, and composites.

10) The method of claim 1 wherein the processing is at least one of cutting, shaping, etching, assembling, welding, progressive dies, stamping, and riveting.

11) A device for processing material, adaptable for use with an existing manufacturing device, comprising:
a. a milling line, comprising:
i. a table on which material may be placed for processing; and
ii. a materials processor;
b. at least one stepper motor disposed proximate the milling line, the stepper motor useful to control a directional movement of material placed onto the milling line for milling, the stepper motor operatively in contact with the material to affect positioning of the material on the table;
c. a mainframe disposed proximate the existing manufacturing device;
d. a positioner disposed proximate a first end of the mainframe;
e. a protected sensor for sensing a predetermined characteristic of the material, the sensor disposed proximate the mainframe and the materials to be processed;
f. a controller for issuing stepper motor commands;
g. a measurement sensor disposed proximate the mainframe, the sensor capable of measuring a predetermined dimension of the material in real-time; and
h. a computer operatively in communication with the controller and the sensors, the computer programmed to:
i. receive signals from the measurement sensor;
ii. receive the measured predetermined dimensions of the material in real-time from the controller;
iii. issue control directives to the controller for use in controlling the stepper motor; and
iv. concurrently generate a certification of the measured predetermined dimensions.

12) The system of claim 11 further comprising a plurality of stepper motors.

13) The system of claim 11 further comprising a tensioner connected to the stepper motor for maintaining a predetermined pressure between the stepper motor and the material.

14) The system of claim 11 wherein the measurement sensor is at least partially in physical contact with the material to be processed.

15) The system of claim 11 wherein the measurement sensor comprises pressure sensors, acoustic sensors, and optical sensors.

16) A device for processing a material, comprising:
a. a milling table for movably accepting material to be processed;
b. a plurality of stepper motors operatively connected to the milling table, at least one first stepper motor being capable of moving the material in a first plane;
c. a materials processor;
d. a measurement sensor situated within a sensor housing;
e. a controller operatively connected to the measurement sensor and the plurality of stepper motors; and
f. a computer operatively in communication with the controller;
g. wherein
i. the computer calculates an adjustment of the material on the milling table using a sensed measurement;
ii. the computer provides the controller with data useful in controlling at least one of the stepper motors based on the calculated adjustment; and
iii. the computer concurrently generates a certification of the sensed measurements.

17) The system of claim 17 further comprising a tensioner connected to at least one of the plurality of stepper motors for maintaining a predetermined pressure between the stepper motor and the material.

18) The system of claim 17 wherein the measurement sensor is at least partially in physical contact with the material to be processed.

19) The system of claim 17 wherein the measurement sensor comprises pressure sensors, acoustic sensors, and optical sensors.
